(19) United States
(12) Patent Application Publication
(10) Pub. No.: US 2014/0159875 A1
(43) Pub. Date: Jun. 12, 2014

(54) TERMINAL AND OPERATION CONTROL METHOD THEREOF

(71) Applicant: Electronics and Telecommunications Research Institute, Daejeon (KR)

(72) Inventors: KANG BOK LEE, Daejeon (KR); Kyu-Ha Baek, Daejeon (KR); Ji Man PARK, Daejeon (KR); DONG-PYO KIM, Daejeon (KR); Jin-Yeong Kang, Daejeon (KR); Lee-Mi DO, Daejeon (KR)

(73) Assignee: Electronics and Telecommunications Research Institute, Daejeon (KR)

(21) Appl. No.: 14/065,558

(22) Filed: Oct. 29, 2013

(30) Foreign Application Priority Data
Dec. 11, 2012 (KR) 10-2012-0143856

(51) Int. Cl. G06K 7/10

(52) U.S. Cl. CPC G06K 7/10207
USPC 340/10.5

(57) ABSTRACT

A terminal and an operation control method thereof are disclosed. A terminal performs an authentication procedure upon receiving a tag device's information from the tag device. If the tag device is identified as a registered tag device in the authentication procedure, initial data corresponding to a function to control the terminal even in a power-saving mode or a lock mode is received from the tag device, and the function corresponding to the initial data is performed.

### CROSS-REFERENCE TO RELATED APPLICATION

This application claims priority to and the benefit of Korean Patent Application No. 10-2012-0143856 filed in the Korean Intellectual Property Office on Dec. 11, 2012, the entire contents of which are incorporated herein by reference.

### BACKGROUND OF THE INVENTION

(a) Field of the Invention

The present invention relates to a terminal and an operation control method thereof.

(b) Description of the Related Art

These days, mobile terminals such as mobile phones have come into widespread use as basic items. Among them, smartphones have a camera function and multimedia functions, such as saving and displaying photos, music, video, etc., as well as a simple voice call function. Also, smartphones may be connected to a network such as the internet to browse a wide variety of information and download and use various convenient functions.

Particularly, the latest terminals are equipped with a short-range wireless communication function such as NFC (near field communication) and Bluetooth, and the area of use of this function is expanding day by day. A number of techniques have been proposed to enable a terminal equipped with the short-range wireless communication function to control mobile terminals with the use of an external reader. Examples of these techniques include restricting the ringtone, camera, phone call functions, etc., of terminals. However, these techniques are only applicable when terminals are in normal operating condition and not applicable when mobile phones are in power-saving mode or locked.

As numerous hardware functions are integrated into terminals, and more and more functions are always on by upper-layer software, a.k.a. applications, the power-saving mode is used to increase battery run time. Also, terminals include a lock mode function to ensure security and protect personal information.

Such power-saving mode and lock mode functions are automatically activated unless a user continues to interface with their terminal. In order to resume the normal use, the users need to type in a password code or equivalents. That is, the user has to enter a pattern, a pin number, a password code, or the like to unlock their terminal. All the functions of the terminal cannot be restored to normal use unless the user enters a proper password code. After a password code is properly authenticated, the terminal returns from the power-saving mode or lock mode to the normal mode, and the display functions becomes stronger. Also, the user can use all the functions of the terminal, including phone call function, text function, etc., under normal conditions. As for conventional terminals, a user input has to be done through physical contact in order to resume the normal operating condition.

However, such a procedure might be rather counterproductive under emergency conditions or when the user cannot enter a password code, although it is useful when protecting information on the phone and restricting the functions the user does not intend to use.

### SUMMARY OF THE INVENTION

The present invention has been made in an effort to provide a terminal which enables minimal use of terminal functions without direct input from a user even under a power-saving mode or a lock mode, and an operation control method thereof.

An exemplary embodiment of the present invention provides a method for controlling the operation of a terminal that performs short-range communication with a tag device. The method may include: receiving the tag device's information from the tag device; comparing the tag device's information with pre-registered information and performing an authentication procedure; if the tag device is identified as a registered tag device in the authentication procedure, receiving, from the tag device, initial data corresponding to a function to control the terminal even in the power-saving mode or the lock mode; and performing the function corresponding to the initial data.

The method may further include registering the tag device's information.

The registering may include receiving the tag device's information from the tag device, and storing the tag device's information.

The registering may further include transmitting the initial data to the tag device.

The tag device's information may be the unique number or user information of the tag device.

The initial data may correspond to the terminal's call function or text function.

The performing of the function corresponding to the initial data may include performing the function corresponding to the initial data in the power-saving mode or lock mode.

Another exemplary embodiment of the present invention provides a terminal. The terminal may include: a short-range communication module that performs short-range communication with an external tag device; and a processor that is connected to the short-range communication module, and receives the tag device's information from the tag device and authenticates the tag device, wherein upon receiving initial data corresponding to a function to control the terminal in a power-saving mode or a lock mode, the processor may perform the function corresponding to the initial data.

The processor may register the tag device's information before authenticating the tag device.

The tag device's information may be a unique number or user information of the tag device.

The initial data may correspond to the terminal's call function or text function.

The short-range communication module may include at least one of an NFC module and a Bluetooth module.

Yet another exemplary embodiment of the present invention provides a tag device. The tag device may include: a short-range communication module that performs short-range communication with a terminal; and a processor that is connected to the short-range communication module, and transmits data for authentication to the terminal and performs an authentication procedure, wherein the processor may transmit initial data corresponding to a function to control the terminal in a power-saving mode or a lock mode so that the terminal performs the function corresponding to the initial data.

According to an exemplary embodiment of the present invention, various functions of a terminal can be performed by controlling the terminal by means of a tag device, even when the terminal is in a power-saving mode or a lock mode.

### BRIEF DESCRIPTION OF THE DRAWINGS

FIG. 1 is a view showing an overall system including a terminal and a tag device in accordance with an exemplary embodiment of the present invention.

FIG. 2 is a view showing a procedure for pre-registering a tag device in a terminal in accordance with an exemplary embodiment of the present invention.

FIG. 3 is a view showing a method for controlling a terminal by means of a tag device in accordance with an exemplary embodiment of the present invention.

FIG. 4 is a flowchart showing a method for performing some functions of a terminal by means of a tag device even when the terminal is in the power-saving mode or lock mode.

FIG. 5 is a view showing the internal configuration of a terminal in accordance with an exemplary embodiment of the present invention.

FIG. 6 is a view showing the internal configuration of a tag device in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a mobile station (MS), a mobile terminal (MT), an advanced mobile station (AMS), a high reliability mobile station (HR-MS), a subscriber station (SS), a portable subscriber station (PSS), an access terminal (AT), user equipment (UE), and so on, or may include all or some functions of the terminal, the MT, the AMS, the HR-MS, the SS, the PSS, the AT, and the UE.

Throughout the specification, unless explicitly described to the contrary, the word “comprise” and variations such as “comprises” or “comprising” will be understood to imply the inclusion of stated elements but not the exclusion of any other elements.

Hereinafter, a terminal and an operation control method thereof in accordance with an exemplary embodiment of the present invention will be described.

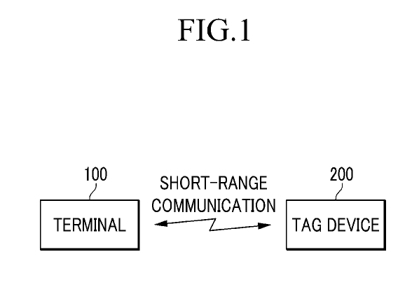

FIG. 1 is a view showing an overall system including a terminal and a tag device in accordance with an exemplary embodiment of the present invention.

As shown in FIG. 1, a terminal 100 performs various kinds of operations to be explained below through short-range communication with the tag device 200. The short-range communication may include NFC (near field communication) communication, Bluetooth communication, ZigBee communication, and so on.

The terminal 100 refers to various kinds of terminals that a user can carry. The tag device 200 may be installed in various locations, like being attached to a PC, kept in a purse, or attached to a car.

When a terminal 100 in power-saving mode or lock mode makes contact with an external tag device 200 (for short-range communication purposes), a function requested by the tag device 200 is automatically implemented. At this point, the power-saving mode or lock mode of the terminal 100 is not disabled, but performs the function (e.g., call and text (SMS) functions) requested by the tag device 200 in the power-saving mode or lock mode, such as display off and keyboard off. The tag device 200 is registered in advance in the terminal 100 through pre-registration to establish short-range communication with the terminal 100, and pre-stores the functions to be performed in the power-saving mode or lock mode in an internal memory.

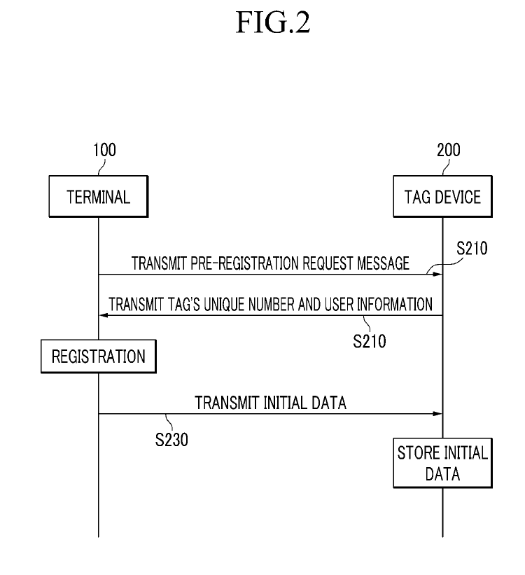

First, referring to FIG. 2, a procedure for pre-registering the tag device 200 in the terminal 100 will be discussed.

FIG. 2 is a view showing a procedure for pre-registering a tag device 200 in a terminal 100 in accordance with an exemplary embodiment of the present invention.

As shown in FIG. 2, first of all, the terminal 100 transmits a pre-registration request message to the tag device 200 in the first communication session between the terminal 100 and the tag device 200 (S210).

Upon receiving a pre-registration request message, the tag device 200 transmits its unique number (ID or serial number) and user information to the terminal 100 (S220).

The terminal 100 registers the received unique number and user information of the tag device therein, and stores information about this registration in a memory.

Then, the terminal 100 transmits initial data to the tag device 200 (S230). The initial data represents various functions to control the terminal 100 even in the power-saving mode or lock mode. For example, the initial data may be predefined variously by the user as: phone call+phone number, SMS+text, and so on.

Upon receiving the initial data, the tag device 200 stores the initial data in a memory.

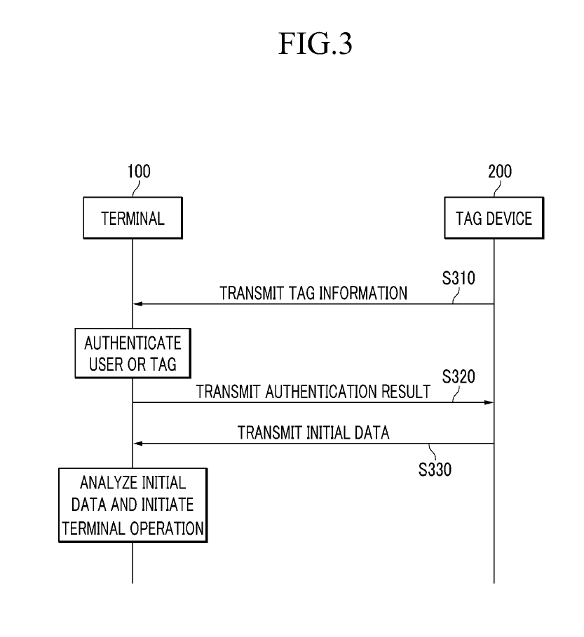

Upon completion of the registration, the terminal 100 may perform the functions represented by the initial data by means of the tag device 200, which will be described in detail with reference to FIG. 3.

FIG. 3 is a view showing a method for controlling the terminal 100 by means of a tag device 200 in accordance with an exemplary embodiment of the present invention.

Firstly, when the terminal 100 in the power-saving mode or lock mode makes contact with the tag device 200, or the tag device 200 makes contact with the terminal 100, short-range communication is performed between the terminal 100 and the tag device 200. Herein, as shown in FIG. 3, the tag device 200 transmits its tag information (S310). The tag information is the unique number (ID or serial number) or user information of the tag device described with respect to the above registration procedure.

Upon receiving the tag information of the tag device 200, the terminal 100 compares the pre-registered tag information (the tag device's unique number or user information) with the received tag information, and authenticates the user or the tag. Once the authentication is properly performed, the terminal 100 transmits an authentication result to the tag device 200 (S320).

Upon receiving a result of proper authentication from the terminal 100, the tag device 200 transmits the pre-stored initial data to the terminal 100 (S330).

Upon receiving the initial data, the terminal 100 analyzes the received initial data and performs the function corresponding to the initial data. If the initial data is phone call+phone number, the terminal 100 places a phone call to the phone number even in the power-saving mode or lock mode. If the initial data is SMS+text, the terminal 100 transmits the text to the phone number even in the power-saving mode or lock mode.

Meanwhile, if the tag information received from the tag device 200 and the pre-registered information are different, all the subsequent steps will be omitted, and the terminal 100 will remain in the power-saving mode or lock mode.

All the steps shown in FIG. 3 are performed through short-range communication between the tag device 200 and the terminal 100 even if the user does not release the power-saving mode or lock mode of the terminal 100. That is, the call function or the texting function can be performed by controlling the terminal 100 by means of the tag device 200.

Accordingly, in accordance with an exemplary embodiment of the present invention, when the user cannot enter text or a pattern to release the power-saving mode or lock mode of the terminal, like while driving, various functions of the terminal can be performed without the user's key operation. Also, a reserved task can be easily performed when the user is in urgent or emergency situations.

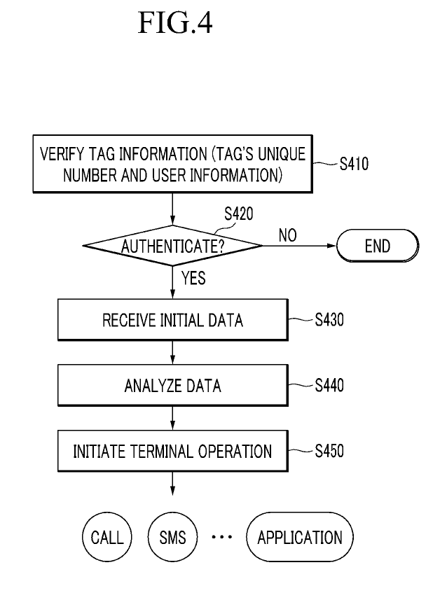

FIG. 4 is a flowchart showing a method for performing some functions of a terminal 100 by means of a tag device 200 even when the terminal 100 is in the power-saving mode or lock mode.

If a pre-registered tag device 200 makes enough contact with the terminal 100 to perform short-range communication with the terminal 100, the tag device 200 transmits tag information to the terminal 100. The terminal 100 compares the received tag information with the existing registered (stored) tag information (tag's unique number or user information), and performs a verification (authentication) procedure (S410).

If the received tag information is identical to the existing registered tag information, the terminal 100 performs the following step S430, or otherwise, finishes the procedure (S420).

Next, in the step S430, the terminal 100 receives initial data from the tag 200, and analyzes the received initial data (S440).

The terminal 100 performs the terminal's function corresponding to the initial data according to an analysis result of the initial data (S450). The terminal's function to be performed may include a call function, a text (SMS) function, or other various kinds of application functions.

FIG. 5 is a view showing the internal configuration of a terminal 100 in accordance with an exemplary embodiment of the present invention.

As shown in FIG. 5, the terminal 100 in accordance with the exemplary embodiment of the present invention includes a processor 120, a memory 140, and a radio frequency (RF) module 160. The processor 120 may be configured to implement the above-explained procedures and methods (methods of FIGS. 3 and 4). The processor 120 in accordance with the exemplary embodiment of the present invention performs the terminal's function corresponding to the initial data received from the tag device 200, as well as the pre-registration of the tag device 200.

The memory 140 is connected with the processor 120, and stores various kinds of information related to the operation of the processor 120. The memory 140 in accordance with the exemplary embodiment of the present invention stores the tag information (tag's unique number and user information) received in the pre-registration of the tag device 200 and the initial data to be implemented.

The short-range communication module 160 is connected with the processor 120, and transmits or receives a radio signal. The short-range communication module 160 in accordance with the exemplary embodiment of the present invention may include at least one of an NFC (near field communication) module, a Bluetooth module, and a ZigBee module. The terminal 100 may have a single antenna or multiple antennas.

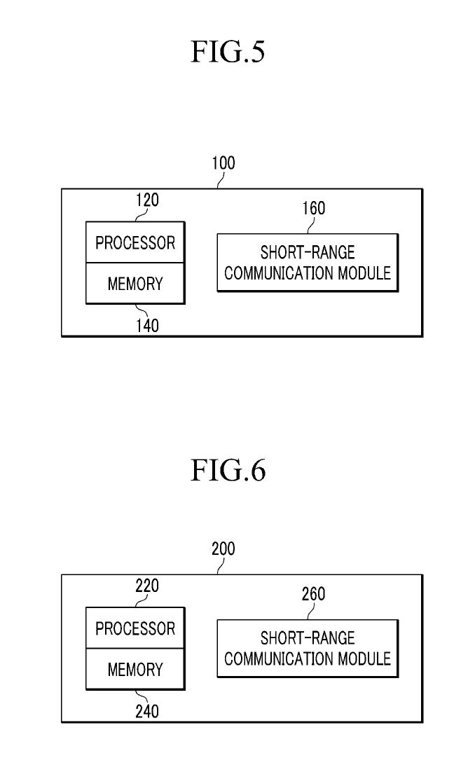

FIG. 6 is a view showing the internal configuration of a tag device 200 in accordance with an exemplary embodiment of the present invention.

As shown in FIG. 6, the tag device 200 in accordance with the exemplary embodiment of the present invention includes a processor 220, a memory 240, and a radio frequency (RF) module 260. The processor 220 may be configured to implement the above-explained procedures and methods (methods of FIGS. 3 and 4). The processor 220 in accordance with the exemplary embodiment of the present invention performs the pre-registration of the tag device 200, and stores the initial data received from the terminal 100.

The memory 240 is connected with the processor 220, and stores various kinds of information related to the operation of the processor 220. The memory 240 in accordance with the exemplary embodiment of the present invention stores the tag information (tag's unique number and user information) required in the pre-registration of the tag device 200 and the initial data received from the terminal 100.

The short-range communication module 260 is connected with the processor 220, and transmits or receives a radio signal. The short-range communication module 260 in accordance with the exemplary embodiment of the present invention may include at least one of an NFC (near field communication) module, a Bluetooth module, and a ZigBee module. The tag device 200 may have a single antenna or multiple antennas.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling operation of a terminal that performs short-range communication with a tag device, the method comprising:
receiving the tag device's information from the tag device;
comparing the tag device's information with pre-registered information and performing an authentication procedure;
if the tag device is identified as a registered tag device in the authentication procedure, receiving, from the tag device, initial data corresponding to a function to control the terminal even in a power-saving mode or a lock mode; and
performing the function corresponding to the initial data.

2. The method of claim 1, further comprising registering the tag device's information.

3. The method of claim 2, wherein
the registering comprises:
receiving the tag device's information from the tag device; and
storing the tag device's information.

4. The method of claim 3, further comprising transmitting the initial data to the tag device.

5. The method of claim 1, wherein the tag device's information is the unique number or user information of the tag device.

6. The method of claim 1, wherein the initial data corresponds to the terminal's call function or text function.

7. The method of claim 1, wherein the performing of the function corresponding to the initial data comprises performing the function corresponding to the initial data in the power-saving mode or lock mode.

8. A terminal comprising:
a short-range communication module that performs short-range communication with an external tag device; and
a processor that is connected to the short-range communication module, and receives the tag device's information from the tag device and authenticates the tag device,
wherein upon receiving initial data corresponding to a function to control the terminal in a power-saving mode or a lock mode, the processor performs the function corresponding to the initial data.

9. The terminal of claim 8, wherein the processor registers the tag device's information before authenticating the tag device.

10. The terminal of claim 8, wherein the tag device's information is a unique number or user information of the tag device.

11. The terminal of claim 8, wherein the initial data corresponds to the terminal's call function or text function.

12. The terminal of claim 8, wherein the short-range communication module comprises at least one of an NFC module and a Bluetooth module.

13. A tag device comprising:
a short-range communication module that performs short-range communication with a terminal; and
a processor that is connected to the short-range communication module, and transmits data for authentication to the terminal and performs an authentication procedure,
wherein the processor transmits initial data corresponding to a function to control the terminal in a power-saving mode or a lock mode so that the terminal performs the function corresponding to the initial data.
